(19) United States
(12) Patent Application Publication
(10) Pub. No.: US 2025/0203521 A1
(43) Pub. Date: Jun. 19, 2025

(54) METHOD, DEVICE AND COMPUTER STORAGE MEDIUM FOR COMMUNICATION

(71) Applicant: NEC CORPORATION, Tokyo (JP)

(72) Inventor: Gang WANG, Beijing (CN)

(73) Assignee: NEC CORPORATION, Tokyo (JP)

(21) Appl. No.: 18/846,334

(22) PCT Filed: Mar. 16, 2022
(86) PCT No.: PCT/CN2022/081198

§ 371 Date: Sep. 12, 2024

(51) Int. Cl. H04W 52/02; H04W 76/27; H04W 76/38

(52) U.S. Cl. CPC H04W 52/0235; H04W 52/028; H04W 76/27; H04W 76/38

(57) ABSTRACT

Embodiments of the present disclosure relate to method, device and computer storage medium for low power (LP) wake-up signal (WUS) monitoring. A terminal device switches on a receiver of the terminal device to monitor a WUS without performing radio resource control (RRC) actions corresponding to RRC idle/inactive process. The terminal device further starts a timer associated with the WUS. If the timer expires, the terminal device performs the RRC actions and switches off the receiver. In this way, the terminal device can decide when to perform the RRC actions and switch off the receiver based on the timer. In this way, the terminal device can acknowledge the situation of connection with a network.

### TECHNICAL FIELD

Embodiments of the present disclosure generally relate to the field of telecommunication, and in particular, to method, device and computer storage medium for low power (LP) wake-up signal (WUS) monitoring.

### BACKGROUND

In a communication system, devices such as terminal devices are battery powered. To support various communication services, such as telephony, video, data, messaging and broadcasts provided by communication systems, the devices need to consume quite a number of battery power. For example, the devices consume tens of millwatts in radio resource control (RRC) idle/inactive state and hundreds of milliwatts in a RRC connected state.

On one hand, it is desirable to prolong battery life of these devices for improving energy efficiency as well as for better user experience. On the other hand, various communication services provided by these devices require low latency. Works are ongoing to introduce a LP WUS monitoring mechanism that can prolong the battery life as well as support low latency.

### SUMMARY

In general, example embodiments of the present disclosure provide method, device and computer storage medium for LP WUS monitoring.

In a first aspect, there is provided a method of communication performed by a terminal device. The method comprises: switching on a receiver of the terminal device to monitor a wake-up signal (WUS) without performing radio resource control (RRC) actions corresponding to RRC idle/inactive process. The method further comprises: starting a timer associated with the WUS. The method further comprises: in accordance with a determination that the timer expires, performing the RRC actions without causing the receiver to monitor the WUS.

In a second aspect, there is provided a terminal device. The terminal device comprises a processor and a memory. The memory is coupled to the processor and stores instructions thereon. The instructions, when executed by the processor, cause the terminal device to perform the method according to the first aspect of the present disclosure.

In a third aspect, there is provided a computer readable medium having instructions stored thereon. The instructions, when executed on at least one processor, cause the at least one processor to perform the method according to the first aspect of the present disclosure.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Through the more detailed description of some embodiments of the present disclosure in the accompanying drawings, the above and other objects, features and advantages of the present disclosure will become more apparent, wherein:

FIG. 1 illustrates an example communication network in which embodiments of the present disclosure can be implemented;

FIG. 2A illustrates example terminal device with a LP receiver;

FIG. 2B illustrates an example scheme of using terminal device with the LP receiver;

FIG. 3 illustrates a signaling flow for communication in accordance with some embodiments of the present disclosure;

FIG. 4A illustrates a flowchart of an example method for WUS monitoring in accordance with some embodiments of the present disclosure;

FIG. 4B illustrates a flowchart of an example state transition process of the terminal device in accordance with some embodiments of the present disclosure;

FIG. 5A illustrates a flowchart of another example method for WUS monitoring in accordance with some embodiments of the present disclosure;

FIG. 5B illustrates a flowchart of another example state transition process of the terminal device in accordance with some embodiments of the present disclosure;

FIG. 6A illustrates a flowchart of a further example method for WUS monitoring in accordance with some embodiments of the present disclosure;

FIG. 6B illustrates the switching processes of the LP receiver and a communication device of the terminal device in accordance with some embodiments of the present disclosure;

FIG. 7A illustrates a flowchart of a still further example method for WUS monitoring in accordance with some embodiments of the present disclosure;

FIG. 7B illustrates a flowchart of a still further example state transition process of the terminal device in accordance with some embodiments of the present disclosure;

FIG. 8 illustrates a flowchart of an example method in accordance with some embodiments of the present disclosure; and

FIG. 9 is a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term ‘terminal device’ refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Ultra-reliable and Low Latency Communications (URLLC) devices, Internet of Everything (IoE) devices, machine type communication (MTC) devices, device on vehicle for V2X communication where X means pedestrian, vehicle, or infrastructure/network, devices for Integrated Access and Backhaul (IAB), Space borne vehicles or Air borne vehicles in Non-terrestrial networks (NTN) including Satellites and High Altitude Platforms (HAPs) encompassing Unmanned Aircraft Systems (UAS), extended Reality (XR) devices including different types of realities such as Augmented Reality (AR), Mixed Reality (MR) and Virtual Reality (VR), the unmanned aerial vehicle (UAV) commonly known as a drone which is an aircraft without any human pilot, devices on high speed train (HST), or image capture devices such as digital cameras, sensors, gaming devices, music storage and playback appliances, or Internet appliances enabling wireless or wired Internet access and browsing and the like. The ‘terminal device’ can further has ‘multicast/broadcast’ feature, to support public safety and mission critical, V2X applications, transparent IPv4/IPv6 multicast delivery, IPTV, smart TV, radio services, software delivery over wireless, group communications and IoT applications. It may also incorporated one or multiple Subscriber Identity Module (SIM) as known as Multi-SIM. The term “terminal device” can be used interchangeably with a UE, a mobile station, a subscriber station, a mobile terminal, a user terminal or a wireless device.

The term “network device” refers to a device which is capable of providing or hosting a cell or coverage where terminal devices can communicate. Examples of a network device include, but not limited to, a Node B (NodeB or NB), an evolved NodeB (eNodeB or eNB), a next generation NodeB (gNB), a transmission reception point (TRP), a remote radio unit (RRU), a radio head (RH), a remote radio head (RRH), an IAB node, a low power node such as a femto node, a pico node, a reconfigurable intelligent surface (RIS), and the like. The terminal device or the network device may have Artificial intelligence (AI) or Machine learning capability. It generally includes a model which has been trained from numerous collected data for a specific function, and can be used to predict some information.

The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory (memories) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware.

As used herein, the singular forms “a”, “an” and “the” are intended to include the plural forms as well, unless the context clearly indicates otherwise. The term “includes” and its variants are to be read as open terms that mean “includes, but is not limited to.” The term “based on” is to be read as “based at least in part on.” The term “one embodiment” and “an embodiment” are to be read as “at least one embodiment.” The term “another embodiment” is to be read as “at least one other embodiment.” The terms “first,” “second,” and the like may refer to different or same objects. Other definitions, explicit and implicit, may be included below.

In some examples, values, procedures, or apparatus are referred to as “best,” “lowest,” “highest,” “minimum,” “maximum,” or the like. It will be appreciated that such descriptions are intended to indicate that a selection among many used functional alternatives can be made, and such selections need not be better, smaller, higher, or otherwise preferable to other selections.

The terminal device or the network device may have Artificial intelligence (AI) or Machine learning capability. It generally includes a model which has been trained from numerous collected data for a specific function, and can be used to predict some information.

The terminal or the network device may work on several frequency ranges, e.g. FR1 (410 MHz-7125 MHz), FR2 (24.25 GHz to 71 GHz), frequency band larger than 100 GHz as well as Tera Hertz (THz). It can further work on licensed/unlicensed/shared spectrum. The terminal device may have more than one connections with the network devices under Multi-Radio Dual Connectivity (MR-DC) application scenario. The terminal device or the network device can work on full duplex, flexible duplex and cross division duplex modes.

In one embodiment, a terminal device may be directly communicated with another terminal device in a communication network. Information related with configuration for the terminal device may be transmitted from a network device in the communication network or pre-configured. The information may be transmitted via any of the following: Radio Resource Control (RRC) signaling, Medium Access Control (MAC) control element (CE), Downlink Control Information (DCI) or pre-configuration.

The embodiments of the present disclosure may be performed in test equipment, e.g. signal generator, signal analyzer, spectrum analyzer, network analyzer, test terminal device, test network device, channel emulator.

The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

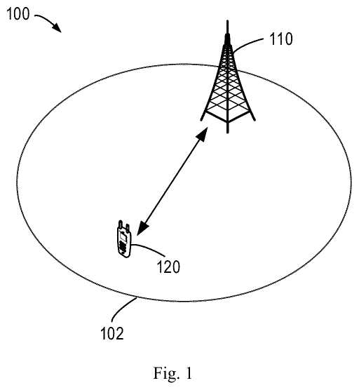

Principle and implementations of the present disclosure will be described in detail below with reference to FIGS. 1-9.

### Example Communication Environment

FIG. 1 shows an example communication network 100 in which embodiments of the present disclosure can be implemented. The network 100 includes a network device 110, a terminal device 120 served by the network device 110. The serving area of the network device 110 is called as a cell 102. It is to be understood that the number of network devices and terminal devices is only for the purpose of illustration without suggesting any limitations. The network 100 may include any suitable number of network devices and terminal devices adapted for implementing embodiments of the present disclosure. Although not shown, it would be appreciated that one or more terminal devices may be in the cell 102 and served by the network device 110.

In the communication network 100, the network device 110 can communicate/transmit data and control information to the terminal device 120 and the terminal device 120 can also communicate/transmit data and control information to the network device 110. A link from the network device 110 to the terminal device 120 is referred to as a downlink (DL), while a link from the terminal device 120 to the network device 110 is referred to as an uplink (UL).

Depending on the communication technologies, the network 100 may be a Code Division Multiple Access (CDMA) network, a Time Division Multiple Address (TDMA) network, a Frequency Division Multiple Access (FDMA) network, an Orthogonal Frequency-Division Multiple Access (OFDMA) network, a Single Carrier-Frequency Division Multiple Access (SC-FDMA) network or any others. Communications discussed in the network 100 may use conform to any suitable standards including, but not limited to, NR, Long Term Evolution (LTE), LTE-Evolution, LTE-Advanced (LTE-A), Wideband Code Division Multiple Access (WCDMA), Code Division Multiple Access (CDMA), CDMA2000, and Global System for Mobile Communications (GSM) and the like. Furthermore, the communications may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols. The techniques described herein may be used for the wireless networks and radio technologies mentioned above as well as other wireless networks and radio technologies. For clarity, certain aspects of the techniques are described below for LTE, and LTE terminology is used in much of the description below.

In the network 100, the terminal device 120 may perform in different mode or state or process. For example, the terminal device 120 in RRC connected state may monitor the physical downlink control channel (PDCCH) to get a downlink (DL) transmission grant for it to receive DL data on the physical downlink shared channel (PDSCH).

Alternatively, the terminal device 120 may perform in RRC_IDLE state (or idle mode) or RRC_INACTIVE state (these two states also can be referred to as RRC idle/inactive state or process). In the RRC idle/inactive state, the terminal device 120 may camp on a cell for example the cell 102 (also referred to as the camped cell). If the camped cell is suitable for the terminal device 120, the terminal device 120 may receive system information from a public land mobile network (PLMN). The network may send a “paging” message for the terminal device 120 on the control channel of the camped cell. The terminal device 120 will then receive the paging message and may respond. In addition, if the terminal device 120 wishes to establish an RRC connection or resume a suspended RRC connection, the terminal device 120 may access the network on the control channel of the camped cell.

In the RRC idle/inactive process, the terminal device 120 may perform various actions. Actions performed by the terminal device 120 in the RRC idle/inactive state or actions corresponding to the RRC idle/inactive process can be referred to as “RRC actions”. Examples of RRC actions may comprise but not limited to monitoring paging procedure, for example monitoring paging occasion (PO), performing neighboring cell measurement and cell (re) selection, performing measurements, performing synchronization signal block (SSB) synchronizing, performing paging reception, etc.

As briefly mentioned above, it is desirable to prolong battery life of these devices for improving energy efficiency as well as for better user experience. Conventionally, it has been proposed to use discontinuous reception (DRX) by the terminal device in RRC idle/inactive state to reduce power consumption. For example, the terminal device performs SSB synchronization and monitors one PO per DRX cycle for potential paging message reception. The DRX cycle value is set in radio frame (rf), such as rf 32, rf 64, rf 128, rf 256, etc. However, the power consumption reduced by using the DRX is still quite high and cannot meet the battery life requirements.

It has also been proposed to use enhanced DRX (eDRX) with a large cycle value by the terminal device in RRC idle/inactive state to reduce power consumption. For example, the terminal device configured with eDRX performs SSB synchronizations and monitors POs during a periodic paging time window (PTW). Outside the PTW, the terminal device may be in long sleep during which the terminal device may not perform the RRC actions such as performing SSB synchronization or monitoring the POs. The eDRX cycle value is set in hyper frame (hf, hf1=rf1024), for example, hfhalf, hf1, hf2, hf4, . . . , hf256. With the eDRX, the power consumption is dropped, but the latency will be raised. Thus, such approach cannot meet the latency requirement.

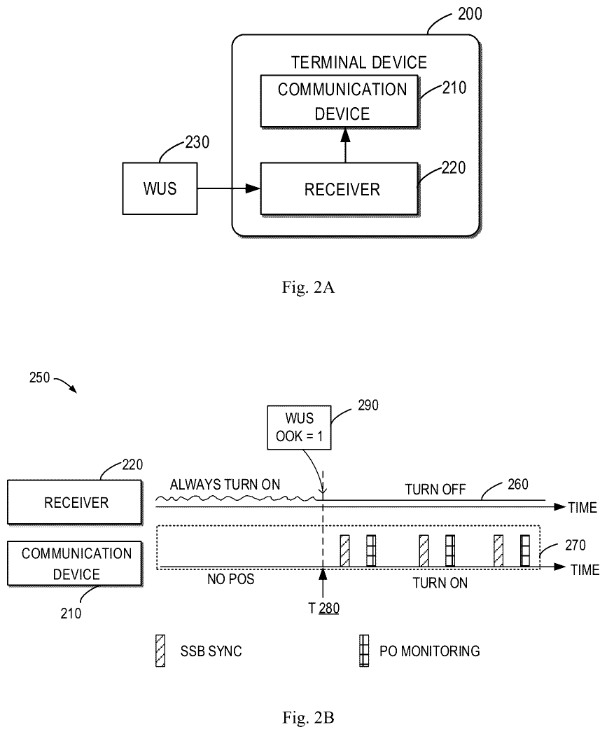

To meet both the battery life requirement and the latency requirement, it has been proposed to use a terminal device with a LP receiver for monitoring WUS, to reduce the power consumption. FIG. 2A illustrates an example terminal device 200 with a receiver 220. The receiver 220 is configured to monitor WUS 230. The WUS 230 may comprise a simple signal, such as 2 amplitude shift keying (ASK) modulation on/off keying (OOK) signal. The receiver 220 only consume quite low power consumption, thus can be also referred to as a LP receiver, an ultra-low power receiver or a LP WUS receiver.

The terminal device 200 also comprises a communication device 210. The communication device 210 is configured to perform normal RRC states, such as RRC connected or RRC idle/inactive states. The communication device 210 may also be referred to as a “main radio”. The communication device 210 may also be referred to as the current NR/LTE communication device.

The terminal device 200 may be in a LP WUS mode. In the LP WUS mode, the communication device 210 is switched off or in deep sleep, and the terminal device 200 may not perform the RRC actions such as monitor paging. In the LP WUS mode, the receiver 220 is switched on to monitor the WUS 230. In some example embodiments, if the receiver 220 does not detect the WUS, the terminal device 220 may maintain the LP WUS mode. In addition, if the monitored WUS 230 is negative, such as OOK=0, the terminal device 200 may maintain the LP WUS mode. Otherwise, if the monitored WUS 230 is positive, such as OOK=1, the terminal device 200 may cause the receiver 220 to transmit a trigger to the communication device 210 to switch on the communication device 210. The terminal device 200 may switch off the receiver 220 as well.

FIG. 2B illustrates an example scheme 250 of using terminal device 200 with the LP receiver 220. In the scheme 250, the power consumption 260 of the receiver 220 is greatly lower than the power consumption 270 of the communication device 210. As illustrated in FIG. 2B, before the time T 280, the receiver 220 always turns on, and the communication device 210 is switched off. It is to be understood that the time T 280 may be a slot, a symbol, a subframe, frame, or other suitable unit. At T 280, the receiver 220 monitors a WUS (with OOK=1) 290, thus the receiver 220 turns off since T 280, and the communication device 210 turns on at T 280. After T 280, the communication device 210 performs the RRC actions such as monitoring PO and SSB synchronization. The power consumption 260 of the receiver 220 during the receiver 220 is turning on may be 100 times less than the power consumption 270 of the communication device 210 when the communication device 210 is switched on. By using the receiver 220 to monitor the WUS 230, both the power consumption and the latency can be reduced.

However, there are still some problems regarding using the receiver to monitor WUS need to be solved. For example, in one situation, for only monitoring WUS by the receiver, if the terminal device is not reachable to the network device anymore, for example, due to mobility or wireless environment, the terminal device may not realize such situation as no measurements for cell selection or reselection. It turns out that the terminal device still monitor the WUS but already disconnected to network. In another situation, when the terminal device is back to normal RRC states (for example, RRC idle/inactive) but there is no paging notification, if the terminal device continues monitoring normal paging, the terminal device will cause more power consumption. In still another situation, if the terminal device is back to normal RRC states but realizes that the camped cell is unsuitable or not available based on measurement or due to cell selection or reselection criteria, how the terminal device should perform in such situation need to be considered.

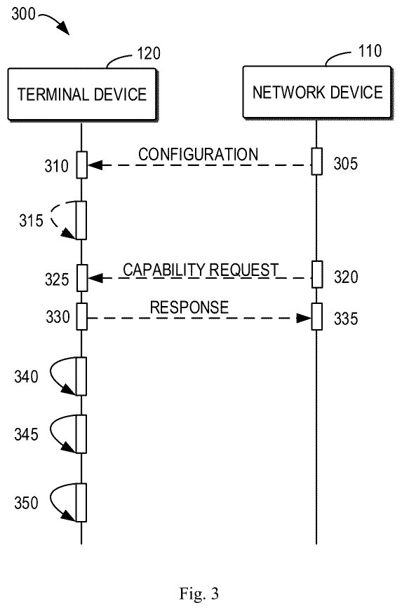

As discussed above, it is very challenging to monitor the WUS by using the receiver. According to embodiments of the present disclosure, there is proposed a solution for the WUS monitoring with the receiver to deal with any of the above mentioned problems. The terminal device switches on a receiver of the terminal device to monitor a WUS without performing RRC actions corresponding to RRC idle/inactive process. The terminal device starts a timer associated with the WUS. Then, if the timer expires, the terminal device performs the RRC actions and switches off the receiver. For example, the terminal device may perform the RRC actions by using a communication device of the terminal device. By using a timer associated with the WUS, the terminal device can determine when to perform the RRC actions and when to switch off or switch on the receiver. In this way, the terminal device may fall back to normal RRC state when needed. To better understand the solution for WUS monitoring with the receiver, some embodiments are now described with reference to FIGS. 3-9.

Example WUS Monitoring with LP Receiver

FIG. 3 illustrates a signaling flow 300 for communication in accordance with some embodiments of the present disclosure. As shown in FIG. 3, the signaling flow 300 involves a terminal device 120 and a network device 110 in FIG. 1. It is to be understood that the signaling flow 300 may involves more devices or less devices, and the number of devices illustrated in FIG. 3 is only for the purpose of illustration without suggesting any limitations.

In operation, the network device 110 may transmit (305) a configuration to the terminal device 120. The configuration may indicate a timer associated with WUS. For example, the network device 110 may transmit the configuration via dedicated RRC signaling, such as RRC Release or RRC Reconfiguration. For another example, network device 110 may transmit the configuration via system information. In such cases, the timer may be included in system information block (SIB) such as SIBx. In responsive to receiving (310) the configuration, the terminal device 120 may determine (315) the timer associated with the WUS. As used hereinafter, the term “timer associated with the WUS” may also be referred to as “maximum maintenance timer”. The timer may be configured or predefined to be any suitable number of ms, s, min or other time durations.

Alternatively, in some example embodiments, the network device 110 may not need to transmit (305) the configuration to the terminal device 120. The timer associated with the WUS may be predefined. For example, the timer may be predefined in the specification such as TS 38.331 or TS 38.304 or any other suitable speciation. The terminal device 120 may determine (315) the timer based on the predefined timer.

Alternatively, or in addition, a plurality of timers associated with the WUS may be comprised in the received (310) configuration or may be predefined. In such cases, the terminal device 120 may determine (315) the timer from the plurality of timers based on a paging probability (PP). The PP is a non access stratum (NAS) assistance information. In some example embodiments, a plurality of thresholds may be configured or network configured or predefined to decide a PP type. For example, if the PP is less than a first threshold, the PP type is determined as a low PP type. If the PP is greater than the first threshold and less than a second threshold, the PP type is determined as a medium PP type. If the PP is greater than the second threshold and less than a third threshold, then the PP type is determined as a high PP type.

It is to be understood that the number of thresholds may be any suitable number greater than 0. The number of threshold may be less than the number of the plurality of timers by 1. For example, if there is only one threshold, then two PP types may be determined and two timers may correspond to the two PP types. If there are more thresholds, then more fine-grained PP types may be determined and more timers may be correspond to these PP types.

The plurality of timers may be network broadcasted or configured or predefined to correspond to the plurality of PP types, respectively. For example, timer 1 may correspond to low PP type, timer 2 may correspond to medium PP type, and timer 3 may correspond to high PP type. When the terminal device 120 obtains the PP from registration procedure, the terminal device 120 may decide its PP type and determine (315) a corresponding timer from the plurality of timers based on the PP.

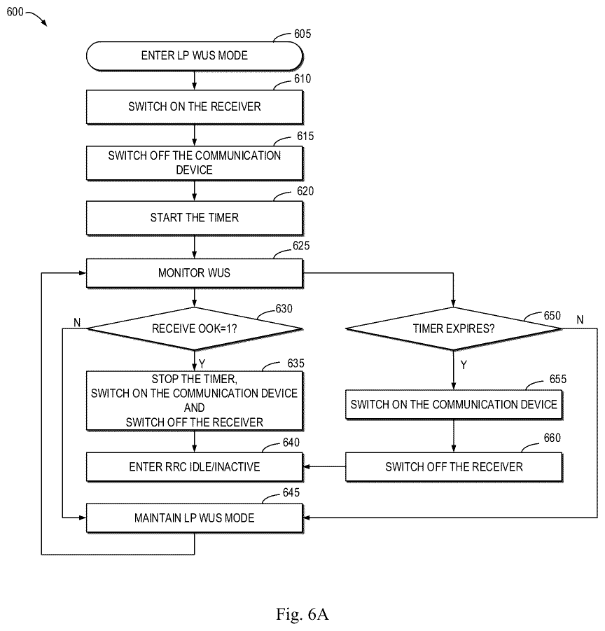

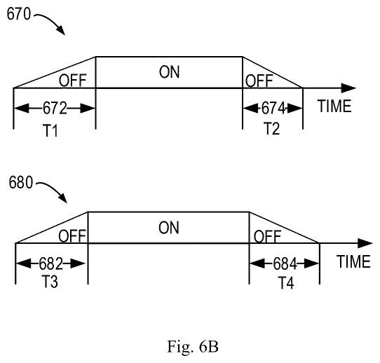

In some example embodiments, the network device 110 may transmit (320) a capability request to the terminal device 120. In response to receiving (325) the capability request from the network device 110, the terminal device 120 may transmit (330) a response to the network device 110. The network device 110 may receive (335) the response. The response may comprise at least one of: a first time duration (also referred to as T3) for switching on a receiver of the terminal device, a second time duration (also referred to as T2) for switching off a communication device of the terminal device, a third time duration (also referred to as T1) for switching on the communication device, or a fourth time duration (also referred to as T4) for switching off the receiver. T1, T2, T3 and T4 may be configured or predefined to be any suitable number of ms, s, min or other time durations. Some example embodiments relating to some of these time durations will be described in details with respect to FIGS. 6A-6B below.

The terminal device 120 switches on (340) a receiver (also referred to as a LP receiver or a LP WUS receiver) of the terminal device 120 to monitor a WUS without performing RRC actions corresponding to RRC idle/inactive process. For example, the terminal device 120 may switch on (340) the receiver and switch off a communication device (also referred to as a main radio) of the terminal device 120 to cease performing the RRC actions. The WUS may comprise 2 amplitude shift keying (ASK) modulation on/off keying (OOK) signal. By monitoring such a simple WUS signal, the power consumption of the terminal device 120 may be greatly reduced.

The terminal device 120 starts (345) the determined (315) timer. If the timer expires, the terminal device 120 performs (350) the RRC actions and switches off the receiver. For example, the terminal device 120 may switch on the communication device to perform the RRC actions and switches off the receiver to cease monitoring the WUS.

It is to be understood that the signaling flow 300 may comprise further operations. For example, the terminal device 120 may receive an indication from the network device 110 indicating to enter the LP WUS mode. The scopes of the present application will not be limited in this regard.

By using the timer, the terminal device may decide when to perform the RRC actions and when to switch off or switch on the receiver. In this way, the terminal device may fall back to normal RRC states no matter whether the terminal device is reachable to network or not. In addition, the terminal device can acknowledge the situation of connection with the network. Thus, using such approach can prolong the battery life as well as support low latency.

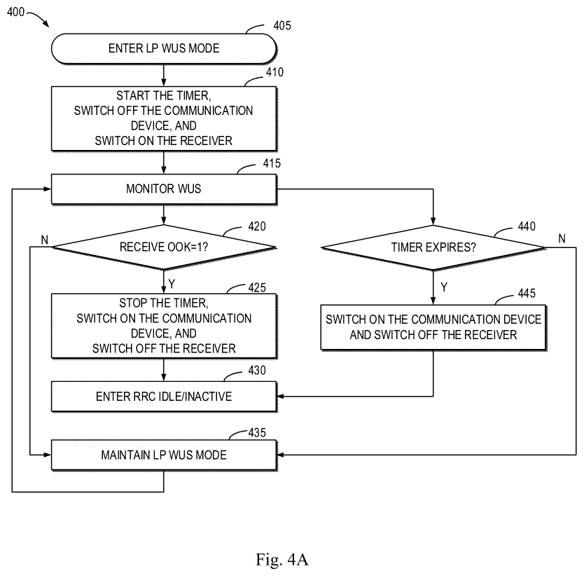

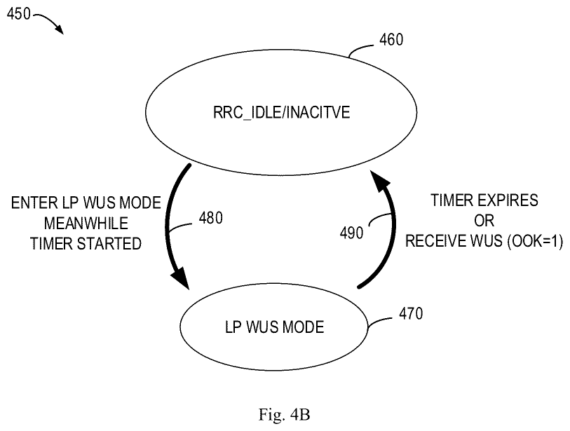

Some example embodiments regarding how to monitor the WUS and when to perform the RRC actions will be described with respect to FIGS. 4A-7B and Tables 1-4 below.

FIG. 4A illustrates a flowchart of an example method 400 for WUS monitoring in accordance with some embodiments of the present disclosure. For the purpose of discussion, the method 400 will be described from the perspective of a terminal device 120 in FIG. 1.

At block 405, the terminal device 120 may initiate entering a LP WUS mode. For example, the terminal device 120 may determine to enter the LP WUS mode based on an indication from the network device 110. For another example, the terminal device 120 may determine to enter the LP WUS mode based on upper layers or based on other determination criteria. In the LP WUS mode, the terminal device 120 may monitor the WUS without performing the RRC actions.

At block 410, the terminal device 120 starts the timer associated with the WUS, switches off a communication device of the terminal device 120 and switches on a receiver of the terminal device 120. For example, the terminal device 120 may start the timer, switch off the communication device and switch on the receiver in parallel.

At block 415, the terminal device 120 monitors the WUS by using the receiver. At block 420, the terminal device 120 determines whether the WUS comprising an OOK equal to 1. If the WUS comprises an OOK equal to 1, the terminal device 120 stops the timer, switches on the communication device and switches off the receiver at block 425. That is, the OOK equal to 1 indicates the switching on of the communication device. For example, the terminal device 120 may stop the timer, switch on the communication device and switch off the receiver in parallel. At block 430, the terminal device 120 may enter RRC idle/inactive state or process. For example, the terminal device 120 may perform paging procedure, SSB reception and measurements corresponding to RRC_IDLE/INACTIVE process. In other words, the terminal device may perform the actions upon going to RRC_IDLE/INACTIVE or exit of the LP WUS mode.

If the WUS does not comprise an OOK equal to 1 (that is, if no WUS is detected or the detected WUS comprise an OOK equal to 0), the terminal device 120 may maintain the LP WUS mode at block 435. For example, the terminal device 120 may maintain monitoring the WUS by the receiver without performing the RRC actions by the communication device. The method 400 may proceed with block 415 after block 435.

At block 440, the terminal device 120 determines whether the timer expires. If the timer expires, the terminal device 120 switches on the communication device and switches off the receiver at block 445. For example, the terminal device 120 may switch on the communication device and the switch off the receiver at block 445 in parallel. That is, the terminal device may perform the RRC actions by the communication device and exit the LP WUS mode.

If the timer does not expire, the terminal device 120 may maintain the LP WUS mode at block 435. Then, the method 400 may proceed with block 415 after block 435.

It is to be understood that some blocks shown in FIG. 4A may be divided into a plurality of sub-blocks. For example, the block 410 or the block 425 may be divided into three sub-blocks, respectively. The block 445 may be divided into two sub-blocks. Each sub-blocks of the corresponding block may be performed in parallel or in sequence.

FIG. 4B illustrates a flowchart of an example state transition process 450 of the terminal device 120 in accordance with some embodiments of the present disclosure. As illustrated, the terminal device 120 may be in either RRC_IDLE/INACTIVE 460 or in LP WUS mode 470. In the RRC_IDLE/INACTIVE 460, the terminal device 120 may monitor paging, perform SSB reception, perform measurements, etc. In the LP WUS mode 470, the terminal device 120 may monitor the WUS by the receiver. In a first transition 480, the terminal device 120 may exit the RRC_IDLE/INACTIVE 460, enter the LP WUS mode 470 and meanwhile the timer is started. If the timer expires or if the monitored WUS comprises an OOK equal to 1, then the terminal device 120 perform a second transition 490. In the second transition 490, the terminal device 120 exits LP WUS mode 470, and enters the RRC_IDLE/INACTIVE 460.

Table 1 below shows an example process performed by the terminal device 120 upon initiation of entering the LP WUS mode in accordance with some embodiments of the present disclosure. The process shown in Table 1 can be implemented as the method 400 in FIG. 4A and/or the state transition process 450 in FIG. 4B.

```
TABLE 1
Upon initiation of entering LP WUS mode, the UE shall:
1> switch on the LP WUS receiver and switch off the main radio;
1> start the maximum maintenance timer;
1> monitor wake-up signal;
1>if wake-up signal is received from LP WUS receiver indicating that switch on the main
radio (i.e. 00K=1):
  2> stop the maximum maintenance timer;
  2> switch on the main radio and switch off LP WUS receiver;
    2> perform SSB reception, paging process and measurements corresponding to
    RRC_IDLE/INACTIVE process (i.e. perform the actions upon going to
    RRC_IDLE/INACTIVE or exit of LP WUS mode).
1> if maximum maintenance timer expires:
  2> switch on the main radio and switch off LP WUS receiver;
    2> perform SSB reception, paging process and measurements corresponding to
    RRC_IDLE/INACTIVE process (i.e. perform the actions upon going to
    RRC_IDLE/INACTIVE or exit of LP WUS mode).
```

By using the method 400 and/or the state transition process 450, or the process described in Table 1, it can make sure that the terminal device can acknowledge the situation of connection with network. The terminal device may fall back to normal RRC states to monitor paging procedure (for example, performing SSB synchronization, measurements, and paging reception) when the timer expires.

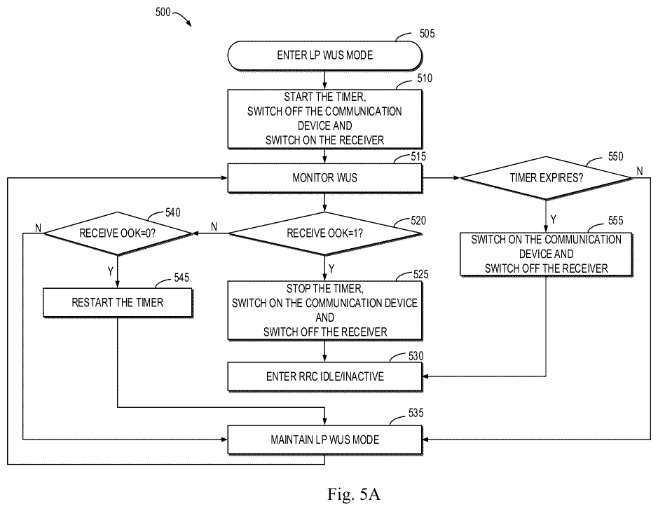

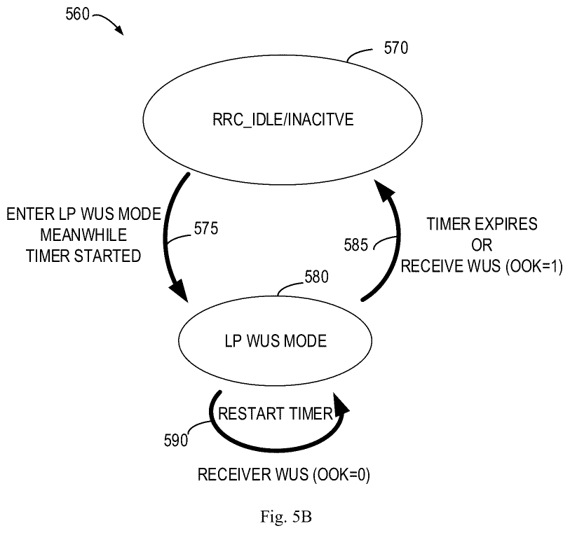

FIG. 5A illustrates a flowchart of another example method 500 for WUS monitoring in accordance with some embodiments of the present disclosure. For the purpose of discussion, the method 500 will be described from the perspective of a terminal device 120 in FIG. 1.

At block 505, the terminal device 120 may initiate entering a LP WUS mode. For example, the terminal device 120 may determine to enter the LP WUS mode based on an indication from the network device 110. For another example, the terminal device 120 may determine to enter the LP WUS mode based on upper layers or based on other determination criteria. In the LP WUS mode, the terminal device 120 may monitor the WUS without performing the RRC actions.

At block 510, the terminal device 120 starts the timer associated with the WUS, switches off a communication device of the terminal device 120 and switches on a receiver of the terminal device 120. For example, the terminal device 120 may start the timer, switch off the communication device and switch on the receiver in parallel or in sequence.

At block 515, the terminal device 120 monitors the WUS by using the receiver. At block 520, the terminal device 120 determines whether the WUS comprising an OOK equal to 1. If the WUS comprises an OOK equal to 1, the terminal device 120 stops the timer, switches on the communication device and switches off the receiver at block 525. For example, the terminal device 120 may stop the timer, switch on the communication device and switch off the receiver in parallel or in sequence. At block 530, the terminal device 120 may enter RRC idle/inactive state or process. For example, the terminal device 120 may perform paging procedure, SSB reception and measurements corresponding to RRC_IDLE/INACTIVE process. In other words, the terminal device may perform the actions upon going to RRC_IDLE/INACTIVE or exit of the LP WUS mode.

If the WUS does not comprise an OOK equal to 1 (that is, if no WUS is detected or the detected WUS comprise an OOK equal to 0), the terminal device 120 may determine whether the WUS comprises an OOK equal to 0 at block 540. If the terminal device 120 determines that the WUS comprises an OOK equal to 0, then the terminal device 120 restarts the timer at block 545. In this way, the 1 bit information (i.e., the OOK signal) equal to 0 (reserved) can be used for network available indication. By restarting the timer based on the network available indication, the terminal device can acknowledge the situation of connection with network.

After restarting the timer at block 545, the terminal device 120 may maintain the LP WUS mode at block 535. In addition, if no WUS is detected by the terminal device 120, the terminal device 120 may maintain the LP WUS mode at block 535. For example, the terminal device 120 may maintain monitoring the WUS by the receiver without performing the RRC actions by the communication device. The method 500 may proceed with block 515 after block 535.

At block 550, the terminal device 120 determines whether the timer expires. If the timer expires, the terminal device 120 switches on the communication device and switches off the receiver at block 555. For example, the terminal device 120 may switch on the communication device and the switch off the receiver at block 555. That is, the terminal device may perform the RRC actions by the communication device and exit the LP WUS mode.

If the timer does not expire, the terminal device 120 may maintain the LP WUS mode at block 535. Then, the method 500 may proceed with block 515 after block 535.

It is to be understood that some blocks shown in FIG. 5A may be divided into a plurality of sub-blocks. For example, the block 510 or the block 525 may be divided into three sub-blocks, respectively. The block 555 may be divided into two sub-blocks. Each sub-blocks of the corresponding block may be performed in parallel or in sequence.

FIG. 5B illustrates a flowchart of another example state transition process 560 of the terminal device in accordance with some embodiments of the present disclosure. As illustrated, the terminal device 120 may be in either RRC_IDLE/INACTIVE 570 or in LP WUS mode 580. In the RRC_IDLE/INACTIVE 570, the terminal device 120 may monitor paging, perform SSB reception, perform measurements, etc. In the LP WUS mode 580, the terminal device 120 may monitor the WUS by the receiver. In a first transition 575, the terminal device 120 may exit the RRC_IDLE/INACTIVE 570, enter the LP WUS mode 580 and meanwhile the timer is started. If the timer expires or if the monitored WUS comprises an OOK equal to 1, then the terminal device 120 perform a second transition 585. In the second transition 585, the terminal device 120 exits LP WUS mode 580, and enters the RRC_IDLE/INACTIVE 570. FIG. 5B also shows an operation 590. If the monitored WUS comprises an OOK equal to 0, the terminal device 120 performs the operation 590 to restart the timer.

Table 2 below shows an example process performed by the terminal device 120 upon initiation of entering the LP WUS mode in accordance with some embodiments of the present disclosure. The process shown in Table 2 can be implemented as method 500 in FIG. 5A and/or the state transition process 560 in FIG. 5B.

```
TABLE 2
Upon initiation of entering LP WUS mode, the UE shall:
1> switch on the LP WUS receiver and switch off the main radio;
1> start the maximum maintenance timer;
1> monitor wake-up signal;
1> if wake-up signal is received from LP WUS receiver indicating that switch on the main
radio (i.e. 00K=1):
  2> stop the maximum maintenance timer;
  2> switch on the main radio and switch off LP WUS receiver;
    2> perform SSB reception, paging process and measurement corresponding to
    RRC_IDLE/INACTIVE process (i.e. perform the actions upon going to
    RRC_IDLE/INACTIVE or exit of LP WUS mode);
1> if wake-up signal is received from LP WUS receiver indicating that there is no need to
switch on the main radio (i.e. OOK=0):
  2> restart the maximum maintenance timer;
  2> maintain the LP WUS mode;
1> if the maximum maintenance timer expires:
  2> switch on the main radio and switch off LP WUS receiver;
    2> perform SSB reception, paging process and measurement corresponding to
    RRC_IDLE/INACTIVE process (i.e. perform the actions upon going to
    RRC_IDLE/INACTIVE or exit of LP WUS mode).
```

By using the method 500 and/or the state transition process 560 and/or the process described in Table 2, it can make sure that the terminal device can acknowledge the situation of connection with network. The terminal device may fall back to normal RRC states to monitor paging procedure (for example, performing SSB synchronization, measurements, and paging reception) when the timer expires. In such embodiments, the reception of WUS equal to 0 (or OOK equal to 0)) indicates that the terminal device is not required to back to normal RRC states and the network device is available by restarting the timer.

FIG. 6A illustrates a flowchart of a further example method 600 for WUS monitoring in accordance with some embodiments of the present disclosure. For the purpose of discussion, the method 600 will be described from the perspective of a terminal device 120 in FIG. 1.

At block 605, the terminal device 120 may initiate entering a LP WUS mode. For example, the terminal device 120 may determine to enter the LP WUS mode based on an indication from the network device 110. For another example, the terminal device 120 may determine to enter the LP WUS mode based on upper layers or based on other determination criteria. In the LP WUS mode, the terminal device 120 may monitor the WUS without performing the RRC actions.

At block 610, the terminal device 120 switches on a receiver of the terminal device 120. For example, the terminal device 120 switches on the receiver at a first time slot. At block 615, the terminal device 120 switches off the communication device of the terminal device 120 after a first time duration since block 610. For example, the terminal device 120 may switch off the communication device at a second time slot being the first time duration after the first time slot. The first time duration (also referred to as T3) represents a time duration for the receiver to switch on. It is to be understood that the time unit of the time duration or time offset may be a slot, a symbol, a subframe, frame, or other suitable unit.

At block 620, the terminal device 120 starts the timer associated with the WUS. For example, the terminal device 120 may start the timer after the first time duration since block 610. Alternatively, the terminal device 120 may start the timer after a second time duration since block 610. The second time duration comprises the first time duration and a further time duration T2 which represents a time duration for the communication device to switch off.

At block 625, the terminal device 120 monitors the WUS by using the receiver. At block 630, the terminal device 120 determines whether the WUS comprising an OOK equal to 1. If the WUS comprises an OOK equal to 1, the terminal device 120 stops the timer, switch ones the communication device and switches off the receiver at block 635. For example, the terminal device 120 may stop the timer, switch on the communication device and switch off the receiver for example in parallel. At block 640, the terminal device 120 may enter RRC idle/inactive state or process. For example, the terminal device 120 may perform paging procedure, SSB reception and measurements corresponding to RRC_IDLE/INACTIVE process. In other words, the terminal device may perform the actions upon going to RRC_IDLE/INACTIVE or exit of the LP WUS mode.

If the WUS does not comprise an OOK equal to 1, the terminal device 120 may maintain the LP WUS mode at block 645. For example, the terminal device 120 may maintain monitoring the WUS by the receiver without performing the RRC actions by the communication device. The method 600 may proceed with block 625 after block 645.

At block 650, the terminal device 120 determines whether the timer expires. If the timer expires, the terminal device 120 switches on the communication device at block 655. At block 660, the terminal device 120 switches off the receiver. For example, the terminal device 120 may switch off the receiver after a third time duration since block 655. The third time duration (also referred to as T1) represents a time duration for the communication device to switch on. With blocks 655 and 660, the terminal device may perform the RRC actions by the communication device and exit the LP WUS mode.

If the timer does not expire, the terminal device 120 may maintain the LP WUS mode at block 645. Then, the method 600 may proceed with block 625 after block 645.

It is to be understood that some blocks shown in FIG. 6A may be divided into a plurality of sub-blocks. For example, the block 635 may be divided into three sub-blocks. Each sub-blocks of the corresponding block may be performed in parallel or in sequence.

FIG. 6B illustrates the switching process 670 of the communication device and the switching process 680 of the LP receiver in accordance with some embodiments of the present disclosure. In the switching process 670, the communication device uses a T1 672 to switch on, and uses a T2 674 to switch off. Similarly, in the switching process 680, the receiver uses a T3 682 to switch on, and uses a T4 684 to switch off. The time durations of T1, T2, T3 and T4 may be different or be the same.

Recalling that in FIG. 3, the terminal device 120 may transmit (330) the response to the capability request to the network device 110. The response may comprise capability information comprising at least one of the above T1 672, T2 674, T3 682 and T4 684.

Table 3 below shows an example process performed by the terminal device 120 upon initiation of entering the LP WUS mode in accordance with some embodiments of the present disclosure. The process shown in Table 3 can be implemented as method 600 in FIG. 6A.

```
TABLE 3
Upon initiation of entering LP WUS mode, the UE shall:
1> switch on the LP WUS receiver;
1> switch off the main radio after T3;
1> start the maximum maintenance timer right after T2 or T3; (note: this is 2 options)
1> monitor wake-up signal;
1>if wake-up signal is received from LP WUS receiver indicating that switch on the main
radio (i.e. 00K=1):
  2> stop the maximum maintenance timer;
    2> switch on the main radio and switch off LP WUS receiver; (note: this case no need
    “after T1” as UE has confirmed OOK=1)
    2> perform SSB reception, paging process and measurement corresponding to
    RRC_IDLE/INACTIVE process (i.e. perform the actions upon going to
    RRC_IDLE/INACTIVE or exit of LP WUS mode).
1> if maximum maintenance timer expires:
  2> switch on the main radio;
  2> switch off LP WUS receiver after T1;
    2> perform SSB reception, paging process and measurement corresponding to
    RRC_IDLE/INACTIVE process (i.e. perform the actions upon going to
    RRC_IDLE/INACTIVE or exit of LP WUS mode).
```

By using the method 600 and/or the process described in Table 3, the time needed by the communication device and/or the receiver to start and/or stop may be taken into consideration. In this way, timer operation can be linked to the start/stop of the communication device and the receiver. Thus, the timer design can be more precisely, so that can improve the terminal device performance and experience.

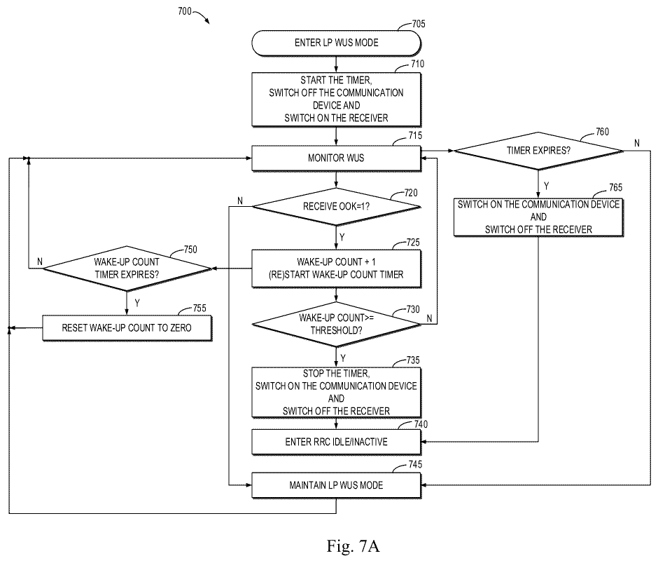

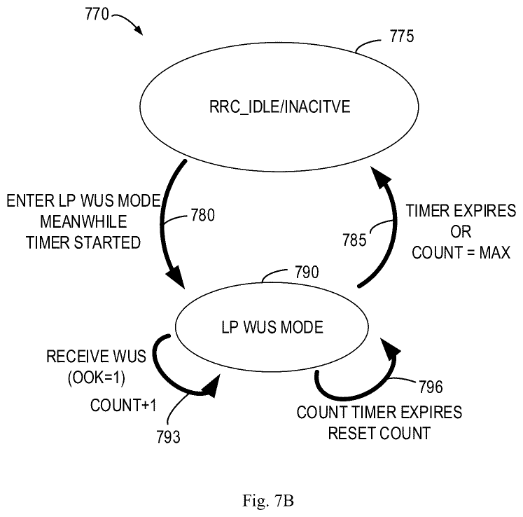

FIG. 7A illustrates a flowchart of a still further example method 700 for WUS monitoring in accordance with some embodiments of the present disclosure. For the purpose of discussion, the method 700 will be described from the perspective of a terminal device 120 in FIG. 1.

At block 705, the terminal device 120 may initiate entering a LP WUS mode. For example, the terminal device 120 may determine to enter the LP WUS mode based on an indication from the network device 110. For another example, the terminal device 120 may determine to enter the LP WUS mode based on upper layers or based on other determination criteria. In the LP WUS mode, the terminal device 120 may monitor the WUS without performing the RRC actions.

At block 710, the terminal device 120 starts the timer associated with the WUS, switches off a communication device of the terminal device 120 and switches on a receiver of the terminal device 120. For example, the terminal device 120 may start the timer, switch off the communication device and switch on the receiver in parallel or in sequence.

At block 715, the terminal device 120 monitors the WUS by using the receiver. At block 720, the terminal device 120 determines whether the WUS comprising an OOK equal to 1. If the WUS comprises an OOK equal to 1, the terminal device 120 increments a wake-up count (also referred to as a first number or wake-up-count) by 1. In addition, the terminal device 120 starts or restarts a wake-up count timer (also referred to as a wake-up-count-timer). The wake-up count may be a variable of the terminal device 120. The wake-up count may be an integer. The wake-up count timer may also be referred to as a second timer. In some example embodiments, the wake-up count timer may be configured by network via dedicated RRC signaling (RRC Release or RRC configuration) or system information. Alternatively, the wake-up count timer may be predefined. The wake-up count timer may be configured or predefined to be any suitable number of ms, s, min or other time durations.

At block 730, the terminal device 120 determines whether the wake-up count exceeds a threshold. That is, the terminal device 120 counts the first number (i.e., the wake-up count) of monitored WUSs indicating to perform the RRC actions, and determines whether the first number exceeds a threshold (also referred to as a threshold number or maxofwake-up-count). The threshold may be predefined to be any suitable integer. Alternatively, the threshold may be configured by network via dedicated RRC signaling (RRC Release or RRC configuration) or system information. If the terminal device 120 determines that the wake-up count exceeds the threshold, the terminal device 120 stops the timer, switches on the communication device and switches off the receiver at block 730. For example, the terminal device 120 may stop the timer, switch on the communication device and switch off the receiver in parallel or in sequence.

At block 740, the terminal device 120 may enter RRC idle/inactive state or process. For example, the terminal device 120 may perform paging procedure, SSB reception and measurements corresponding to RRC_IDLE/INACTIVE process. In other words, the terminal device may perform the actions upon going to RRC_IDLE/INACTIVE or exit of the LP WUS mode.

If the terminal device 120 determines that the wake-up count does not exceed the threshold, the terminal device 120 may return to monitor the WUS at block 715.

At block 750, the terminal device 120 may determine whether the wake-up count timer expires. If the wake-up count timer expires, the terminal device 120 resets the wake-up count to zero. That is, if the wake-up count is below the threshold and the wake-up count timer expires, the terminal device 120 sets the wake-up count to zero. Then, the terminal device 120 may return to monitor the WUS at block 715. If the wake-up count timer does not expire, the terminal device 120 may return to monitor the WUS at block 715.

At block 760, the terminal device 120 determines whether the timer associated with the WUS expires. If the timer expires, the terminal device 120 switches on the communication device and switches off the receiver at block 765. For example, the terminal device 120 may switch on the communication device and the switch off the receiver at block 555 in parallel or in sequence. That is, the terminal device may perform the RRC actions by the communication device and exit the LP WUS mode.

If the timer does not expire, the terminal device 120 may maintain the LP WUS mode at block 745. Then, the method 700 may return to proceed with block 715 after block 745.

It is to be understood that some blocks shown in FIG. 7A may be divided into a plurality of sub-blocks. For example, the block 710 or the block 735 may be divided into three sub-blocks, respectively. The block 765 may be divided into two sub-blocks. Each sub-blocks of the corresponding block may be performed in parallel or in sequence.

FIG. 7B illustrates a flowchart of a still further example state transition process 770 of the terminal device 120 in accordance with some embodiments of the present disclosure. As illustrated, the terminal device 120 may be in either RRC_IDLE/INACTIVE 775 or in LP WUS mode 790. In the RRC_IDLE/INACTIVE 775, the terminal device 120 may monitor paging, perform SSB reception, perform measurements, etc. In the LP WUS mode 790, the terminal device 120 may monitor the WUS by the receiver. In a first transition 780, the terminal device 120 may exit the RRC_IDLE/INACTIVE 775, enter the LP WUS mode 790 and meanwhile the timer is started. If the timer expires or if the wake-up count is equal to the threshold (maximum value of the wake-up count), then the terminal device 120 perform a second transition 785. In the second transition 785, the terminal device 120 exits LP WUS mode 790, and enters the RRC_IDLE/INACTIVE 775. FIG. 7B also shows an operation 793 and an operation 796. If the monitored WUS comprises an OOK equal to 1, the terminal device 120 may perform the operation 793 to increment the wake-up count by 1. If the wake-up count timer expires, the terminal device 120 may perform the operation 796 to reset the wake-up count timer to zero.

Table 4 below shows an example process performed by the terminal device 120 upon initiation of entering the LP WUS mode in accordance with some embodiments of the present disclosure. The process shown in Table 4 can be implemented as method 600 in FIG. 7A and/or the state transition process 770 in FIG. 7B.

```
TABLE 4
Upon initiation of entering LP WUS mode, the UE shall:
1> switch on the LP WUS receiver and switch off the main radio;
1> start the maximum maintenance timer;
1> monitor wake-up signal;
1>if wake-up signal is received from LP WUS receiver indicating that switch on the main
radio (i.e. 00K=1):
  2> increment wake-up-count by 1;
  2> start or restart wake-up-count-timer;
1> if wake-up-count >= maxofwake-up-count:
  2> stop the maximum maintenance timer;
  2> switch on the main radio and switch off LP WUS receiver;
    2> perform SSB reception, paging process and measurements corresponding to
    RRC_IDLE/INACTIVE process(i.e. perform the actions upon going to
    RRC_IDLE/INACTIVE or exit of LP WUS mode or exit of LP WUS mode);
1> if wake-up-count-timer expires and wake-up-count is less than maxofwake-up-count:
  2> reset wake-up-count to 0;
1> if maximum maintenance timer expires:
  2> switch on the main radio and switch off LP WUS receiver;
    2> perform SSB reception, paging process and measurement corresponding to
    RRC_IDLE/INACTIVE process (i.e. perform the actions upon going to
    RRC_IDLE/INACTIVE or exit of LP WUS mode).
```

By using the method 700 and the state transition process 770, mistakes due to the simple OOK signals may be avoided. The terminal device can be configured a wake-up count to determine that after how many WUS with OOK equal to 1 is received, the terminal device turns on the communication device. In this way, the risk of the terminal device detecting OOK signal incorrectly can be decreased.

It is to be understood that the above described methods 400-700 can be implemented separately or in combination. The scope of the present disclosure is not limited in this regard.

The above examples describe that the terminal device 120 may exit the LP WUS mode based on the expiration of the timer. In addition, or alternatively, in some example embodiments, the terminal device 120 may determine to exit the LP WUS mode based on an indication from upper layers. For example, the terminal device 120 may receive a first indication from upper layer. The first indication indicates to perform the RRC actions and switching off the receiver. Alternatively, the first indication may indicate to switch on the communication device and switch off the receiver. That is, the upper layers request the exit of LP WUS mode. The upper layer is to compare with RRC layer. The upper layer refers to NAS layer of the terminal device 120. The terminal device 120 may switch on the communication device and switch off the receiver. The terminal device 120 may perform the RRC actions, such as SSB reception, paging process and measurements corresponding to the RRC_IDLE/INACTIVE process).

In addition, the terminal device 120 may transmit to the upper layers a second indication. The second indication (also referred to as an exit cause) indicates that performing the RRC actions and switching off the receiver is caused by the first indication. The exit cause may be a NAS information element (IE). For example, the terminal device 120 may indicate the exit of LP WUS mode to upper layers with the exit cause set to “requested by upper layer” or “other”.

In some example embodiments, when the terminal device 120 receives the first indication from the upper layers indicating to exit the LP WUS mode, the terminal device 120 may switch on the receiver and switch off the communication device for example in parallel. Table 5 below shows an example of exit of the LP WUS mode indicated by upper layer in accordance with some embodiments of the present disclosure.

```
TABLE 5
The UE initiate the procedure when upper layers request the exit of LP WUS mode.
The UE shall:
1> if the upper layers indicate exit of LP WUS mode:
  2> switch on the main radio and switch off LP WUS receiver;
    2> perform SSB reception, paging process and measurements corresponding to
    RRC_IDLE/INACTIVE process (i.e. perform the actions upon going to
    RRC_IDLE/INACTIVE or exit of LP WUS mode);
  2> indicate the exit of LP WUS mode to upper layers with the exit cause set to
  “requested by upper layer” or “other”. (optional)
```

Alternatively, or in addition, in some example embodiments, the terminal device 120 may switch off the receiver after a time duration for example the T1 672 of FIG. 6B since switching on the communication device.

Table 6 below shows another example of exit of the LP WUS mode indicated by upper layer in accordance with some embodiments of the present disclosure. In the example of Table 6, the time needed by the communication device to start has been taken into consideration. In this way, timer operation can be linked to the start of the communication device. Thus, the timer design can be more precisely, so that can improve the terminal device performance and experience.

```
TABLE 6
The UE initiate the procedure when upper layers request the exit of LP WUS mode.
The UE shall:
1> if the upper layers indicate exit of LP WUS mode:
  2> switch on the main radio;
  2> switch off LP WUS receiver after T1;
    2> perform SSB reception, paging process and measurements corresponding to
    RRC_IDLE/INACTIVE process (i.e. perform the actions upon going to
    RRC_IDLE/INACTIVE or exit of LP WUS mode);
    2> indicate the exit of LP WUS mode to upper layers with the exit cause set to
    “requested by upper layer” or “other”. (optional)
```

By indicating the terminal device to exit the LP WUS mode by upper layers, the terminal device can exit the LP WUS mode by itself. In this way, it can make sure that the terminal device can flexibly control the LP WUS mode.

Embodiments regarding when to exit the LP WUS mode have been described. In some example embodiments, after the terminal device exits the LP WUS mode and performs the RRC actions, the terminal device may return back to the LP WUS mode under some conditions. Those conditions for the terminal device to return back to the LP WUS mode will be described in details below.

In some example embodiments, the terminal device 120 falls back to normal RRC states due to the timer expiring or due to exit request requested by upper layer, the terminal device 120 may perform a cell selection or reselection criteria or perform measurements to determine whether a cell being camped on by the terminal device 120 is unsuitable for the terminal device 120. If the camped cell is unsuitable for the terminal device 120 due to cell (re) selection criteria or based on measurements, the terminal device 120 may perform cell selection or reselection process, and disable the receiver from monitoring the WUS. In other words, the terminal device 120 may disable LP WUS feature.

In this way, when the terminal device is back to normal RRC states but realizes that the cell is unsuitable or not available, the terminal device may initial cell selection or reselection procedure and may disable the LP WUS feature.

In some example embodiments, the terminal device 120 may disable the LP WUS feature until next network indication or for a while by implementation. For example, the terminal device 120 may receive an indication indicating to monitor the WUS from the network device 110. In responsive to receiving the indication, the terminal device 120 may enter the LP WUS mode, for example by switching on the receiver to monitor the WUS and switching off the communication device to cease performing the RRC actions. For another example, if the terminal device 120 determines that the receiver has been disabled for a time duration exceeding a time threshold, the terminal device 120 may decide to enter the LP WUS mode, for example, by switching on the receiver to monitor the WUS and switching off the communication device to cease performing the RRC actions. The time threshold may be (pre) configured or predefined.

By disabling the LP WUS feature under some conditions (for example, the unsuitable camped cell) and re-entering the LP WUS mode under conditions such as the network indication or exceeding the time threshold, it can make sure the robust of this LP WUS monitoring mechanism.

Table 7 below shows an example process performed by the terminal device 120 upon the terminal device 120 falls back to normal RRC states due to the timer or exit request by upper layer in accordance with some embodiments of the present disclosure. In Table 7, the terminal device 120 may be referred to as UE.

```
TABLE 7
Upon fallback to normal RRC states due to maximum maintenance timer,
or exit request by upper layer, UE shall:
1> if UE is not suitable for the camped cell due to cell (re)selection
criteria (or based on measurements):
  2> perform cell (re)selection process to find a suitable cell to camp on
  in accordance with the cell (re)selection process as specified in TS
  3X.304;
  2> UE may disable LP WUS feature (1. until next network indication or
  2. for a while by implementation).
```

In some example embodiments, the terminal device 120 may determine a number of paging occasions (POs) (denoted as NumPO). The NumPO may be configured by the network via dedicated RRC signaling or system information. Alternatively, the NumPO may be predefined. The NumPO may be configured or predefined to be any suitable integer. While the terminal device 120 performs the RRC actions, if there is no paging notification (responding to the terminal device 120) received from the network during a PO time duration, the terminal device 120 may fall back to LP WUS MODE. For example, the terminal device 120 may switch on the receiver to monitor the WUS and switch off the communication device. The PO time duration represents a time duration during which the terminal device 120 monitors NumPO paging cycles.

Table 8 below shows another example process performed by the terminal device 120 upon the terminal device 120 falls back to normal RRC states in accordance with some embodiments of the present disclosure. In Table 8, the terminal device 120 may be referred to as UE.

```
TABLE 8
Upon fallback to normal RRC states, UE shall:
1> if UE has monitored NumPO paging cycles but there is no any paging
notification (responding to this UE) sent from network:
  2> UE fallback to LP WUS mode.
  2> monitor wake-up signal.
```

In some example embodiments, the terminal device 120 may start a third timer (also referred to as an inactive timer). The third timer may be configured by the network via dedicated RRC signaling or system information. Alternatively, the third timer may be predefined. The third timer may be configured or predefined to be any suitable number of ms, s, min or other time durations. The third timer may indicate that if no paging received during the third timer, the terminal device 120 may return back to LP WUS mode.

For example, the terminal device 120 starts the third timer since the terminal device 120 performs the RRC actions and switches off the WUS. If no paging notification is received from the network during the third timer, the terminal device 120 may fall back to the LP WUS mode. For example, the terminal device 120 may switch on the receiver to monitor the WUS, and switch off the communication device. In some example embodiments, the third timer may be set to multiple times of paging cycles.

Table 9 below shows a further example process performed by the terminal device 120 upon the terminal device 120 falls back to normal RRC states in accordance with some embodiments of the present disclosure. In Table 9, the terminal device 120 may be referred to as UE.

```
TABLE 9
Upon fallback to normal RRC states, UE shall:
1> start inactive timer if configured;
1> if UE does not receive any paging notification (responding to this UE)
during inactive timer if configured:
  2> UE fallback to LP WUS mode.
  2> monitor wake-up signal.
```

In this way, if the terminal device back to normal RRC states but there is no paging notification, the terminal device can return back to LP WUS mode again based on the above conditions. By returning back to LP WUS mode based on the above conditions, the power consumption of the terminal device can be further reduced. In this way, the battery life of the terminal device may be prolonged.

### Example Method and Device

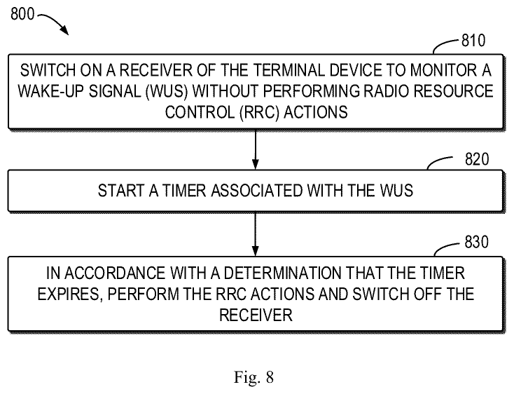

FIG. 8 illustrates a flowchart of an example method 800 in accordance with some embodiments of the present disclosure. The method 800 can be implemented at a terminal device 120 as shown in FIG. 1. It is to be understood that the method 800 may include additional blocks not shown and/or may omit some blocks as shown, and the scope of the present disclosure is not limited in this regard. For the purpose of discussion, the method 800 will be described from the perspective of the terminal device 120 with reference to FIG. 1.

At block 810, the terminal device 120 switches on a receiver of the terminal device 120 to monitor a WUS, without performing RRC actions corresponding to RRC idle/inactive process. In some example embodiments, in switching on the receiver to monitor the WUS without performing the RRC actions, the terminal device 120 may switch off a communication device of the terminal device 120 to cease performing the RRC actions.

In some example embodiments, in switching on the receiver to monitor the WUS without performing the RRC actions, the terminal device 120 may switch on the receiver to monitor the WUS; and switch off a communication device of the terminal device to cease performing the RRC actions after a first time duration. The first time duration represents a time duration for the receiver to switch on. In some example embodiments, in starting the timer, the terminal device 120 may start the timer after the first time duration or a second time duration. The second time duration comprises the first time duration and a further time duration for the communication device to switch off.

At block 820, the terminal device 120 starts a timer associated with the WUS. For example, the timer may be predefined. Alternatively, in some example embodiments, the terminal device 120 may receive a configuration from a network device 110. The configuration indicating the timer. The terminal device 120 may determine the timer based on the configuration.

Alternatively, or in addition, the terminal device 120 may receive a plurality of timers configured by a network device 110. The terminal device 120 may determine the timer from the plurality of timers based on a paging probability (PP).

At block 830, the terminal device 120 in accordance with a determination that the timer expires, performs the RRC actions and switches off the receiver. In some example embodiments, in performing the RRC actions and switching off the receiver, the terminal device 120 may switch on a communication device of the terminal device 120 to perform the RRC actions, and switch off the receiver to cease monitoring of the WUS by the receiver. For example, in switching off the receiver, the terminal device 120 may switch off the receiver after a third time duration since switching on the communication device. The third time duration represents a time duration for the communication device to switch on.

In some example embodiment, the terminal device 120 may receive a first indication from upper layer. The first indication indicates to perform the RRC actions and switch off the receiver. The terminal device 120 may further transmit to the upper layers a second indication. The second indication indicates that performing the RRC actions and switching off the receiver is caused by the first indication.

In some example embodiment, the terminal device 120 may receive a capability request from a network device 110. In response to receiving the capability request from the network device 110, the terminal device 120 may transmit a response to the network device, the response comprising at least one of: a first time duration for switching on the receiver, a second time duration for switching off a communication device of the terminal device 120, a third time duration for switching on the communication device, or a fourth time duration for switching off the receiver.

In some example embodiment, if a monitored WUS indicating to maintain the WUS by the receiver, the terminal device 120 restarts the timer.

In some example embodiment, if a monitored WUS indicating to perform the RRC actions and switching off the receiver, the terminal device 120 switches on a communication device of the terminal device 120 to perform the RRC actions, switches off the receiver; and stops the timer.

In some example embodiment, the terminal device 120 may count a first number of monitored WUSs indicating to perform the RRC actions while a second timer is running. The second timer is configured by a network device. If the first number exceeds a threshold, the terminal device 120 switches on a communication device of the terminal device 120 to perform the RRC actions; switches off the receiver; and stops the timer. In addition, if the monitored WUS indicating to perform the RRC actions, the terminal device 120 starts or restarts the second timer. Alternatively or in addition, if the first number is below the threshold number and the second timer expires, the terminal device 120 may set the first number to be zero.

In some example embodiments, while the terminal device performs the RRC actions, the circuitry may be further configured to perform cell selection or reselection criteria or perform measurements. If the cell selection or reselection criteria or the measurements indicate that a cell being camped on by the terminal device is unsuitable for the terminal device, the circuitry may be configured to perform the cell selection or reselection process; and disable the receiver from monitoring the WUS.

In some example embodiments, in responsive to receiving, from a network device, an indication indicating to monitor the WUS, the circuitry may be configured to switch on the receiver to monitor the WUS without performing the RRC actions.

Alternatively, or in addition, if the receiver has been disabled for a time duration exceeding a time threshold, the circuitry may be configured to switch on the receiver to monitor the WUS without performing the RRC actions.

In some example embodiments, the circuitry may be configured to start a third timer since the terminal device performs the RRC actions and switches off the WUS. If no paging notification is received from a network device during the third timer, the circuitry may be configured to switch on the receiver to monitor the WUS.

In some example embodiments, while the terminal device performs the RRC actions, if no paging notification is received from the network device during a paging occasion (PO) time duration, the circuitry may be configured to switch on the receiver to monitor the WUS. The PO time duration represents a time duration during which the terminal device monitors a second number of paging cycles.

In some example embodiments, the WUS comprises a 2 amplitude shift keying (ASK) modulation on/off keying (OOK) signal.

Details for WUS monitoring according to the present disclosure have been described with reference to FIGS. 1-8. Now an example implementation of the terminal device 120 will be discussed below. In some embodiments, a terminal device (for example, the terminal device 120) comprises circuitry configured to: switch on a receiver of the terminal device to monitor a WUS, without performing RRC actions corresponding to RRC idle/inactive process. In some example embodiments, in switching on the receiver to monitor the WUS without performing the RRC actions, the circuitry may be configured to switch off a communication device of the terminal device to cease performing the RRC actions.

In some example embodiments, in switching on the receiver to monitor the WUS without performing the RRC actions, the circuitry may be configured to switch on the receiver to monitor the WUS; and switch off a communication device of the terminal device to cease performing the RRC actions after a first time duration. The first time duration represents a time duration for the receiver to switch on. In some example embodiments, in starting the timer, the circuitry may be configured to start the timer after the first time duration or a second time duration. The second time duration comprises the first time duration and a further time duration for the communication device to switch off.

The circuitry is further configured to start a timer associated with the WUS. For example, the timer may be predefined. Alternatively, in some example embodiments, the circuitry may be configured to receive a configuration from a network device 110. The configuration indicating the timer. The circuitry may be configured to determine the timer based on the configuration.

Alternatively, or in addition, the circuitry may be configured to receive a plurality of timers configured by a network device. The circuitry may be configured to determine the timer from the plurality of timers based on a paging probability (PP).

The circuitry is further configured to: in accordance with a determination that the timer expires, performs the RRC actions and switches off the receiver. In some example embodiments, in performing the RRC actions and switching off the receiver, the circuitry may be configured to switch on a communication device of the terminal device to perform the RRC actions, and switch off the receiver to cease monitoring of the WUS by the receiver. For example, in switching off the receiver, the circuitry may be configured to switch off the receiver after a third time duration since switching on the communication device. The third time duration represents a time duration for the communication device to switch on.

In some example embodiment, the circuitry may be configured to receive a first indication from upper layer. The first indication indicates to perform the RRC actions and switch off the receiver. The circuitry may be further configured to transmit to the upper layers a second indication. The second indication indicates that performing the RRC actions and switching off the receiver is caused by the first indication.

In some example embodiment, the circuitry may be configured to receive a capability request from a network device. In response to receiving the capability request from the network device, the circuitry may be configured to transmit a response to the network device, the response comprising at least one of: a first time duration for switching on the receiver, a second time duration for switching off a communication device of the terminal device, a third time duration for switching on the communication device, or a fourth time duration for switching off the receiver.

In some example embodiment, if a monitored WUS indicating to maintain the WUS by the receiver, the circuitry may be configured to restart the timer.

In some example embodiment, if a monitored WUS indicating to perform the RRC actions and switching off the receiver, the circuitry may be configured to switch on a communication device of the terminal device to perform the RRC actions, switch off the receiver; and stop the timer.

In some example embodiment, the circuitry may be configured to count a first number of monitored WUSs indicating to perform the RRC actions while a second timer is running. The second timer is configured by a network device. If the first number exceeds a threshold, the circuitry may be configured to switch on a communication device of the terminal device to perform the RRC actions; switch off the receiver; and stop the timer. In addition, if the monitored WUS indicating to perform the RRC actions, the circuitry may be configured to start or restart the second timer. Alternatively or in addition, if the first number is below the threshold number and the second timer expires, the circuitry may be configured to set the first number to be zero.

In some example embodiments, while the terminal device 120 performs the RRC actions, the terminal device 120 may further perform cell selection or reselection criteria or perform measurements. If the cell selection or reselection criteria or the measurements indicate that a cell being camped on by the terminal device 120 is unsuitable for the terminal device 120, the terminal device 120 may perform the cell selection or reselection process; and disable the receiver from monitoring the WUS.

In some example embodiments, in responsive to receiving, from a network device 110, an indication indicating to monitor the WUS, the terminal device 120 may switch on the receiver to monitor the WUS without performing the RRC actions.

Alternatively, or in addition, if the receiver has been disabled for a time duration exceeding a time threshold, the terminal device 120 may switch on the receiver to monitor the WUS without performing the RRC actions.

In some example embodiments, the terminal device 120 may start a third timer since the terminal device 120 performs the RRC actions and switches off the WUS. If no paging notification is received from a network device 110 during the third timer, the terminal device 120 may switch on the receiver to monitor the WUS.

In some example embodiments, while the terminal device 120 performs the RRC actions, if no paging notification is received from the network device 110 during a paging occasion, PO, time duration, the terminal device 120 may further switch on the receiver to monitor the WUS. The PO time duration represents a time duration during which the terminal device monitors a second number of paging cycles.

In some example embodiments, the WUS comprises a 2 amplitude shift keying (ASK) modulation on/off keying (OOK) signal.

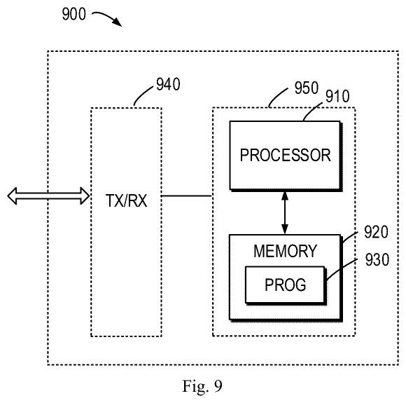

FIG. 9 is a simplified block diagram of a device 900 that is suitable for implementing embodiments of the present disclosure. The device 900 can be considered as a further example implementation of the network device 110 or the terminal device 120 as shown in FIG. 1. Accordingly, the device 900 can be implemented at or as at least a part of the network device 110 or the terminal device 120.

As shown, the device 900 includes a processor 910, a memory 920 coupled to the processor 910, a suitable transmitter (TX) and receiver (RX) 940 coupled to the processor 910, and a communication interface coupled to the TX/RX 940. The memory 910 stores at least a part of a program 930. The TX/RX 940 is for bidirectional communications. The TX/RX 940 has at least one antenna to facilitate communication, though in practice an Access Node mentioned in this application may have several ones. The communication interface may represent any interface that is necessary for communication with other network elements, such as X2 interface for bidirectional communications between eNBs, SI interface for communication between a Mobility Management Entity (MME)/Serving Gateway (S-GW) and the eNB, Un interface for communication between the eNB and a relay node (RN), or Uu interface for communication between the eNB and a terminal device.

The program 930 is assumed to include program instructions that, when executed by the associated processor 910, enable the device 900 to operate in accordance with the embodiments of the present disclosure, as discussed herein with reference to FIGS. 1 and 3-8. The embodiments herein may be implemented by computer software executable by the processor 910 of the device 900, or by hardware, or by a combination of software and hardware. The processor 910 may be configured to implement various embodiments of the present disclosure. Furthermore, a combination of the processor 910 and memory 920 may form processing means 950 adapted to implement various embodiments of the present disclosure.

The memory 920 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 920 is shown in the device 900, there may be several physically distinct memory modules in the device 900. The processor 910 may be of any type suitable to the local technical network, and may include one or more of general purpose computers, special purpose computers, microprocessors, digital signal processors (DSPs) and processors based on multicore processor architecture, as non-limiting examples. The device 900 may have multiple processors, such as an application specific integrated circuit chip that is slaved in time to a clock which synchronizes the main processor.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIG. 3, FIG. 4A, FIG. 5A, FIG. 6A, FIG. 7A and/or FIG. 8. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

1. A method of communication performed by a terminal device, comprising:
switching on a receiver of the terminal device to monitor a wake-up signal, WUS, without performing radio resource control, RRC, actions corresponding to RRC idle/inactive process;
starting a timer associated with the WUS; and
in accordance with a determination that the timer expires, performing the RRC actions and switching off the receiver.

2-8. (canceled)

9. The method of claim 1, further comprising:
receiving a first indication from upper layer, the first indication indicating to perform the RRC actions and switching off the receiver; and
transmitting to the upper layer a second indication, the second indication indicating that performing the RRC actions and switching off the receiver is caused by the first indication.

10. The method of claim 1, further comprising:
in response to receiving a capability request from a network device, transmitting a response to the network device, the response comprising at least one of:
a first time duration for switching on the receiver,
a second time duration for switching off a communication device of the terminal device,
a third time duration for switching on the communication device, or
a fourth time duration for switching off the receiver.

11-15. (canceled)

16. The method of claim 1, while the terminal device performs the RRC actions, the method further comprising:
performing cell selection or reselection criteria or performing measurements;
in accordance with a determination that the cell selection or reselection criteria or the measurements indicates that a cell being camped on by the terminal device is unsuitable for the terminal device,
performing a cell selection or reselection process; and
disabling the receiver from monitoring the WUS.

17. The method of claim 16, further comprising:
in responsive to receiving, from a network device, an indication indicating to monitor the WUS, switching on the receiver to monitor the WUS without performing the RRC actions; or
in accordance with a determination that the receiver has been disabled for a time duration exceeding a time threshold, switching on the receiver to monitor the WUS without performing the RRC actions.

18. (canceled)

19. The method of claim 1, while the terminal device performs the RRC actions, the method further comprising:
in accordance with a determination that no paging notification is received from a network device during a paging occasion, PO, time duration, switching on the receiver to monitor the WUS, the PO time duration representing a time duration during which the terminal device monitors a second number of paging cycles.

20. The method of claim 1, wherein the WUS comprises a 2 amplitude shift keying, ASK, modulation on/off keying, OOK, signal.

21. A terminal device comprising a processor configured to:
switch on a receiver of the terminal device to monitor a wake-up signal, WUS, without performing radio resource control, RRC, actions corresponding to RRC idle/inactive process;
start a timer associated with the WUS; and
in accordance with a determination that the timer expires, perform the RRC actions and switching off the receiver.

22. (canceled)

23. The terminal device of claim 21, wherein the processor is further configured to cause the terminal device to:
receive a first indication from upper layer, the first indication indicating to perform the RRC actions and switching off the receiver; and
transmit to the upper layer a second indication, the second indication indicating that performing the RRC actions and switching off the receiver is caused by the first indication.

24. The terminal device of claim 21, wherein the processor is further configured to cause the terminal device to:
in response to receiving a capability request from a network device, transmit a response to the network device, the response comprising at least one of:
a first time duration for switching on the receiver,
a second time duration for switching off a communication device of the terminal device,
a third time duration for switching on the communication device, or
a fourth time duration for switching off the receiver.

25. The terminal device of claim 21, wherein while the terminal device performs the RRC actions, the processor is further configured to cause the terminal device to:
in accordance with a determination that no paging notification is received from a network device during a paging occasion, PO, time duration, switch on the receiver to monitor the WUS, the PO time duration representing a time duration during which the terminal device monitors a second number of paging cycles.
